(19) United States
(12) Patent Application Publication
(10) Pub. No.: US 2013/0067081 A1
(43) Pub. Date: Mar. 14, 2013

(54) Mobile Device Authentication and Access to a Social Network

(71) Applicants: Bojin Liu, Davis, CA (US); Behrooz Khorashadi, Mountain View, CA (US); Saumitra Mohan Das, San Jose, CA (US)

(72) Inventors: Bojin Liu, Davis, CA (US); Behrooz Khorashadi, Mountain View, CA (US); Saumitra Mohan Das, San Jose, CA (US)

(73) Assignee: QUALCOMM Incorporated, San Diego, CA (US)

(21) Appl. No.: 13/230,444

(22) Filed: Sep. 12, 2011

(51) Int. Cl. G06F 15/173

(52) U.S. Cl. 709/225

(57) ABSTRACT

Disclosed is an apparatus, system, and method to allow a user of a mobile device to access a social network through a router. The mobile device may comprise a user interface and a processor. The processor may be used to: command transmitting a social profile associated with the mobile device to the router to bind the mobile device to the router and to command transmitting social network credentials requested by the router to the router to authenticate the mobile device to the router. Based upon authentication by the router, the mobile device may be permitted to access a social network in accordance with control rules set by the router.

### BACKGROUND

1. Field

The present invention relates generally to mobile device authentication and access to a social network through a router.

2. Relevant Background

Today, the use of mobile electronic devices is widespread. Such mobile electronic devices can: provide a user with wireless phone access, provide Internet access, provide email access, provide the ability to send and receive text messages, allow the user to perform on-line transactions such as on-line shopping and on-line banking, allow the user to access social networks, and to perform other functions such as finding maps to particular locations, etc. Thus, today's mobile electronic devices allow for wireless communication as well as almost all of the Internet features associated with non-mobile computer systems. Examples of such mobile electronic devices include: mobile devices, smart phones, cellular phones, personal digital assistants (PDAs), mobile computers, laptop computers, tablet computers, as well as any other type of portable computer.

The use of mobile devices is widespread due to their ease of use and portability. However, a primary dilemma with mobile devices, is obtaining access to a fast wireless connection for the delivery and receipt of voice and data.

Mobile devices are increasingly utilizing hotspot routers (e.g., relatively short-range wireless routers) using 3G/4G backhauls to gain wireless access. Examples of these types of routers include compact mobile Wi-Fi hotspots or newly opened tethering features provided by many mobile devices themselves. Currently most of these types of routers only allow 3-5 simultaneous connections. However as battery technology continues to improve with the introduction of faster backhaul connections (e.g., HSPA+, LTE, etc.) it can be assumed that the number of connections available through these types of router will continue to increase.

The manner of use of these wireless hotspot routers is different than how other types of access points are typically utilized. In particular, wireless hotspot routers are typically used in a more dynamic context than conventional access points, because with wireless hotspot routers, users are typically on the move and the set of users that may connect to the wireless hotspot router may be much larger and may constantly be changing.

Therefore, it may be beneficial to provide techniques to allow a client mobile device to connect to the wireless hotspot router without a great deal of interruption, such as, having to insert a large amount of information to gain access and approval for the use of the wireless hotspot router. However, at the same time, access to the wireless hotspot router should be secure to prevent unauthorized users from using up data bandwidth of the wireless hotspot router.

### SUMMARY

Aspects of the invention may relate an apparatus, system, and method to allow a user of a mobile device to access a social network through a router. The mobile device may comprise a user interface and a processor. The processor may be used to: command transmitting a social profile associated with the mobile device to the router to bind the mobile device to the router and to command transmitting social network credentials requested by the router to the router to authenticate the mobile device to the router. Based upon authentication by the router, the mobile device may be permitted to access a social network in accordance with control rules set by the router.

### BRIEF DESCRIPTION OF THE DRAWINGS

FIG. 1 is a block diagram of a system in which aspects of the invention related to allowing a mobile device to access a social network through a router may be practiced.

FIG. 2 is a flow diagram to illustrate a process to allow a user of a mobile device to access a social network.

FIG. 3 is a block diagram of an example of authenticating a user of a mobile device to access a social network.

FIG. 4 is a block diagram of an example of providing control rules to a user of a mobile device to access social networks.

FIG. 5 is a block diagram of an example of providing control rules to users of mobile devices to access social networks.

### DETAILED DESCRIPTION

The word “example” or “exemplary” is used herein to mean “serving as an example, instance, or illustration.” Any embodiment described herein as “exemplary” or “example” is not necessarily to be construed as preferred or advantageous over other embodiments.

According to aspects of the invention, a mobile client device user's social network interactions may be leveraged to authenticate and control access to a wireless hotspot router. In particular, matching the social authentication and context of a mobile client device with the tethering wireless hotspot router may be used to determine if access should be given and if so to what level of service. For example, if the client mobile device's phone number is in the wireless hotspot router's contact list then it may imply that some level of access should be given. On the other hand, if the mobile client device user is friend on a social network associated with the owner of the wireless hotspot router, then a higher level of access is provided, such as Internet Access to the social network. These types of associations may be verified without a large amount of manual interruptions to the user of the mobile client device.

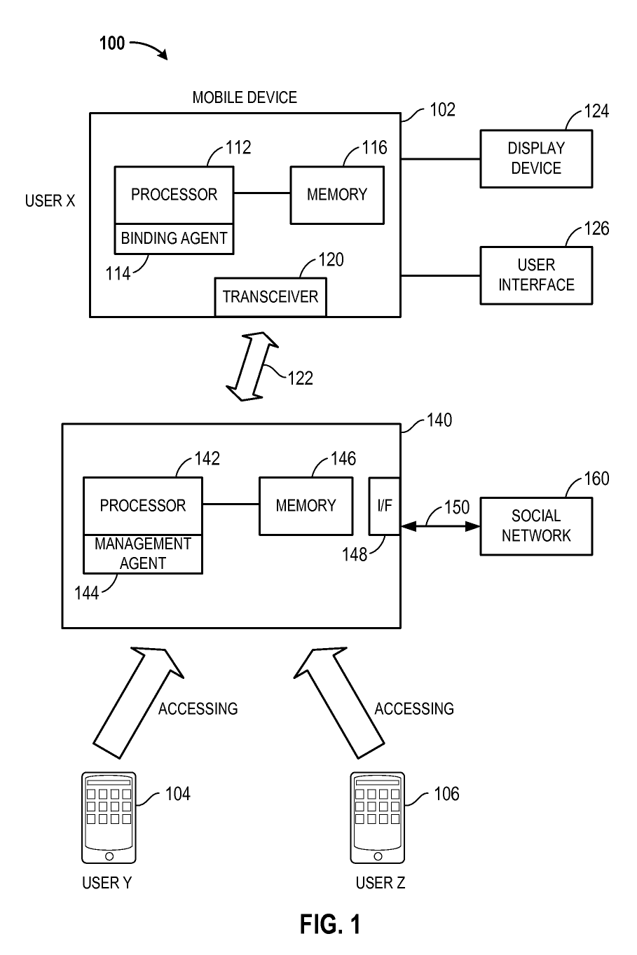

With reference to FIG. 1, aspects of the invention may relate an apparatus, system, and method to allow a user of a mobile device 102 to access a social network 160 through a router 140. FIG. 1 is a block diagram of a system 100 in which aspects of the invention may be practiced. The mobile device 102 may comprise a user interface 126 and a processor 112. The processor 112 may implement a binding agent 114 to: command transmitting a social profile via a wireless link 122 associated with the mobile device to the router 140 to bind the mobile device 102 to the router and to command transmitting social network credentials requested by the router 140 to the router via wireless link 122 to authenticate the mobile device to the router. Based upon authentication by the router 140, the mobile device 102 may be permitted to access a social network 160 or another mobile device (e.g., User Y 104 or User Z 106) in accordance with control rules set by the router.

In one example, mobile device 102 may access a social network 160 through a router 140. Mobile device 102 may include a processor 112, a memory 116, a transceiver 120, a display device 124, and a user interface 126. It should be appreciated that the display device 122 may be a typical display device utilized by a mobile device. User interface 122 may be a keypad, keyboard, or another type of user interface input device, typically used with a mobile device. Transceiver 120 may be a typical transceiver utilized with a mobile device to send and receive voice and data through a wireless link 122. It should be appreciated that mobile device 102 may be any type of mobile device, examples of which include: smart phones, cellular phones, personal digital assistants (PDAs), mobile computers, laptop computers, tablet computers, any other type of portable computer, etc.

Additionally, a microphone (not shown), a power device (not shown), as well as other well known components of mobile devices may be present, but are not shown, for brevity's sake, as they are well known.

In particular, mobile device 102 (e.g., User X) may include a processor 112 and a memory 116 configured to execute instructions for implementing a binding agent 114. Memory 116 may be coupled to processor 112 to store instructions for implementation by the processor 112. Thus, mobile device 102 is configured to execute instructions to implement a binding agent 114 to: command transmitting a social profile via a wireless link 122 associated with the mobile device to the router 140 to bind the mobile device 102 to the router and to command transmitting social network credentials requested by the router 140 to the router via wireless link 122 to authenticate the mobile device to the router. Based upon authentication by the router 140, the mobile device 102 may be permitted to access a social network 160 in accordance with control rules set by the router.

Router 140 may include an interface (I/F) 148, such as, a transceiver or modem to receive and transmit voice and data via link 122 with mobile device 102 and to receive and transmit voice and data via link 150. Link 150 may be wired link or a wireless link. Router 120 may include a processor 142 and a memory 146 configured to execute instructions for implementing a management agent 144. Memory 146 may be coupled to processor 142 to store instructions for implementation by the processor 142. Router 140 is configured to execute instructions to implement a management agent 144 to: request the mobile device 102 to transmit social network credentials to the router via link 122; authenticate the mobile device 102 based upon the social network credentials; and permit access to a social network 160 via I/F 148 and link 150 as well as to other mobile devices (e.g., User Y 104 or User Z 106). As will be described, router 140 under the control of management agent 144 may assign control rules to mobile devices based upon retrieved social network data from the mobile devices to allow or deny access to different types of social network websites 160.

It should be appreciated that router 140 may be a wireless router, a wired router, or another mobile device that acts as a router. As one example, router 140 may be an approximately short-range wireless hotspot router. Therefore, router 140 may hereinafter be described as a wireless hotspot router; however, any type of router may be utilized with aspects of the invention. Further, as shown in FIG. 1, wireless hotspot router 140 may further simultaneously route voice and data for other mobile device 104 and 106 (Users Y and Z).

As an example, wireless hotspot router 140 may utilize 3G/4G backhauls to gain wireless access via link 150. As an example, wireless hotspot router 140 may be a mobile Wi-Fi hotspot or may be a mobile device itself that provides tethering features. As another example, wireless hotspot router 140 may include a wired link 150.

As will be described, according to aspects of the invention, a mobile device user's social network interactions may be leveraged to authenticate and control access to the wireless hotspot router 140 and for access to social network websites 160 and functions. In particular, matching the social authentication and context of a user's mobile client device with the tethering wireless hotspot router 140 may be used to determine if access should be given, and, if so, to what level of service. For example, if the user's mobile device phone number is in the wireless hotspot router's 140 contact list then it may imply that some level of access should be given. On the other hand, if the mobile client device user is friend on a social network 160 of the owner of the wireless hotspot router 140, then it may be that a higher level of access is provided, such as Internet Access to the social network 160 website. As will be described, these types of associations may be verified without manual interruptions of the user's of both the mobile device and the wireless hotspot router 140.

As an example, in one aspect, if the mobile device 102 is already logged onto a social network 160, login credentials are passed on directly through the wireless hotspot router 140 from the mobile device 102 to the social network 160. On the other hand, if the mobile device 120 is not already logged onto a social network 160, the wireless hotspot router 140 redirects the mobile device 140 to the social network 160 such that the user is allowed to enter login credentials.

The term social network 160 is broadly defined and may include a website/server having a plurality of user accounts. The term “social network” may include: a social network server in which “friends” interact with one another by posting/sharing media, pictures, text, multi-media, etc. (e.g., FACEBOOK), an email server in which user's can transmit email to one another, a text server in which “followers/followees” communicate text (e.g., TWITTER), etc. However, it should be appreciated that a “social network” may include any website/server in which data is transferred including websites/servers that: provide phone access (e.g. VoIP), provide email access, provide the ability to send and receive text messages, provide the ability to send and receive media, pictures, text, multi-media, etc., allow the user to perform on-line transactions such as on-line shopping and on-line banking, or to perform any other type of data transfer functions, etc. Thus, the term “social network” may include any website/server having a plurality of user accounts in which data is transferred.

According to one aspect of the invention, a user of wireless device 102 may come into range of wireless hotspot router 140. Processor 112 may implement a binding agent 114 to: command transmitting a social profile via a wireless link 122 associated with the mobile device to the wireless hotspot router 140 to bind the mobile device 102 to the router and to command transmitting social network credentials requested by the wireless hotspot router 140 to the router via wireless link 122 to authenticate the mobile device 102 to the wireless hotspot router 140. Based upon authentication by the wireless hotspot router 140, the mobile device 102 may be permitted to access a social network 160 or another mobile device (e.g., User Y 104 or User Z 106) in accordance with control rules set by the router. Further, it should be appreciated that after the mobile device 102 has been authenticated based on social network credentials by the router 140, the mobile device 102 may be permitted to not only access a social network 160 but may be permitted to access any type of network (e.g., any type of Internet site).

In one aspect, the mobile device 102 (User X) may be the owner of the router 140 and by binding itself to router 104 based upon a social profile and authenticating itself to router 104 based upon social network credentials, mobile device 102 claims ownership of router 104 and can set-up and modify control rules. However, another computing device may also connect to router 140 and after adequate authentication can similarly set-up and modify control rules. As some examples, the social profile may include at least one of a telephone number, an Open ID, an email address, an account on a website, or a username. Further, the social profile may include a physical social interaction including at least one of a location, a meeting, or a calendar event. The social network credential requested may also be data related to the user's social profile. However, the social network credentials may be a password, a public and private key pair, a secret token, etc. As will also be described, other mobile devices 104 and 106 (e.g., User Y and Z) may authenticate themselves to the router 140 based upon social network credentials and may be permitted to access a social network 160 or another mobile device based upon control rules—but because they are not bound to the router and are not owners of the router they cannot change the control rules. Further, it should be appreciated that after the other mobile devices 104 and 106 have been authenticated based on social network credentials by the router 140, the mobile devices 104 and 106 may be permitted to not only access a social network 160 but may be permitted to access any type of network (e.g., any type of Internet site).

In one aspect, as will be described in more detail, the wireless hotspot router 140 under the control of management agent 144 of the processor 142 may retrieve social network data from memory 146 associated with the transmitted social network credentials from the mobile device. The wireless hotspot router 140 may assign control rules to the mobile device based upon the retrieved social network data. Further, the wireless hotspot router 140 may cache social network credentials and social network data into memory 146. More, particularly, wireless hotspot router 140 may allow or deny access of the mobile device to one or more of a plurality of different social networks 160.

It should be appreciated that mobile device 102 (or any mobile device 104, 106, etc.) and wireless hotspot router 140 may communicate with one or more base stations (BS) of a wireless communication system. The wireless communication system may further include one or more base station controllers (BSC) and a core network. Core network may be connected to an Internet and a Public Switched Telephone Network (PSTN) via suitable backhauls. Mobile device 102 and wireless hotspot router 140, hereinafter “the wireless device”, may include various components that perform functions based on signals that are transmitted by or received at the mobile device and router. The wireless device may communicate via one or more wireless communication links that are based on or otherwise support any suitable wireless communication technology. For example, in some aspects the wireless device may be associated with a network. In some aspects the network may comprise a body area network or a personal area network (e.g., an ultra-wideband network). In some aspects the network may comprise a local area network or a wide area network. The wireless device may support or otherwise use one or more of a variety of wireless communication technologies, protocols, or standards such as, for example, CDMA, TDMA, PDMA, SDMA, FDMA, OFDM, OFDMA, WiMAX, Wi-Fi, 3G, 4G, LTE, etc. Similarly, the wireless device may support or otherwise use one or more of a variety of corresponding modulation or multiplexing schemes. The wireless device may thus include appropriate components (e.g., air interfaces) to establish and communicate via one or more wireless communication links using the above or other wireless communication technologies. For example, the wireless device may comprise a wireless transceiver with associated transmitter and receiver components (e.g., a transmitter and a receiver) that may include various components (e.g., signal generators and signal processors) that facilitate communication over a wireless medium.

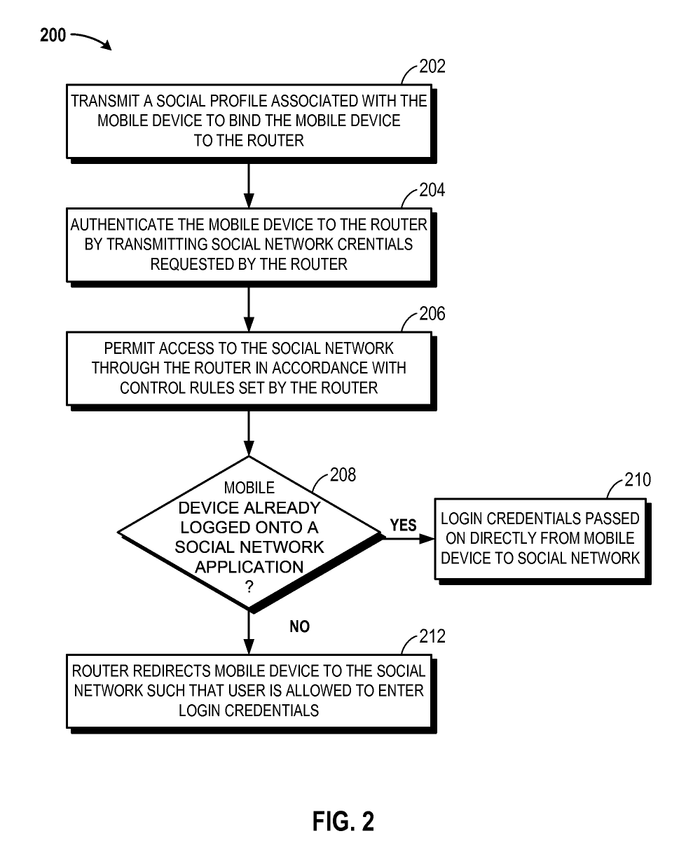

With brief reference to FIG. 2, a flow diagram is shown to illustrate a process 200 to allow a user of a mobile device 102 to access a social network 160, according to one aspect of the invention. At block 202, mobile device 102 transmits a social profile associated with the mobile device 102 to wireless hotspot router 140 to bind the mobile device 102 to wireless hotspot router 140. At block 204, process 200 authenticates the mobile device 102 to the wireless hotspot router 140 by transmitting social network credentials requested by the wireless hotspot router 140 to the router. Based upon authentication by the wireless hotspot router 140, access to the social network 160 is permitted by the router in accordance with control rules set by the router (block 206). In one aspect, if the mobile device 102 is already logged onto a social network 160 (decision block 208), then the user's login credential are passed on directly from the mobile device 102 to the social network 160 (block 210). If not, wireless hotspot router 140 redirects mobile device 102 to the social network 160 such that the user is allowed to enter login credentials at the webpage of the social network (block 212).

In one aspect, the social profile of the mobile device 102 is transmitted to the wireless hotspot router 140. The social profile may include any data that may uniquely identify the user of the mobile device with the operator of the wireless hotspot router 140 or other users of the wireless hotspot router 140. For example, the social profile may include the mobile device user's: accounts on social network websites, email addresses, phone number; and/or physical social interactions: locations, meetings, calendar events, etc. All of these types of social profile information are easily retrievable from the mobile device 102 and may be easily transmitted to the wireless hotspot router 140 for binding. This process may be implemented by processor 112 of mobile device 102 under the control of binding agent 144. Further, the social network credentials requested by the router 140 may be data related to the user's social profile. As an example, mobile device 102 may transmit social profile information via link 122 to wireless hotspot router 140 to indicate to wireless hotspot router 140 that mobile device 102 is User X on social network website Y and email server Z, etc.

The wireless hotspot router 140 may then retrieve and/or cache the mobile device's 102 social relationship/interactions with other users, such as, for example: friend's list on a social network website, followers/followees on a text website, friends that have exchanged emails on an email website, friends that have called and/or text messaged, friends that the user had meetings with and/or calendared meetings at different location and/or at different times, etc.

Further, mobile device 102 may authenticate itself with wireless hotspot router 140 by transmitting social network credentials (e.g., social profile data) requested by wireless hotspot router 140 to authenticate the mobile device 102 to wireless hotspot router 140. As previously described, if social network applications are already logged onto on the mobile device 102, the login credentials can be passed on by the wireless hotspot router 140 to the social network website 160. If the user is not logged onto the social network, after authenticating the mobile device 102 with the wireless hotspot router 140, the mobile device 102 will be directed by the wireless hotspot router 140 to the service of the social network website for logging in. It is beneficial in that user does not have to have security concerns because the user is not providing their username and password to the wireless hotspot router 140.

Moreover, in one aspect, the mobile device 102 may provide batch social network credit credentials for batch authentications to wireless hotspot router 140 via the wireless link 122 with all the mobile device's social network credentials to indicate the user's different “roles” in the host router's social context. For example, the mobile device 102 may batch authenticate with wireless hotspot router 140: email accounts, social network accounts, text message accounts, etc. As one particular example, an OpenID could be used to link the user with his/her phone actions (phone number, calls history, SMS, etc.) This may be used to inform wireless hotspot router 140 that this User X of mobile device 102 is associated with a particular social network, email website, text website, with phone number xxx, etc. In particular, after successfully authenticating the mobile device user's identity, the wireless hotspot router 140 may begin to match the user with its social relationship/interaction with the host wireless hotspot router 140. Examples of this may include determining: if the user is on one of the host's social networks friends list, if the user has exchanged email with the host, if the user has had phone calls with the host, if the user has been having regular meetings with the host at specific time/location, etc

Access by the wireless hotspot router 140 to a social network 160 may be granted to the mobile device 102 user according to their social relationships/interaction with the host wireless hotspot router 140. The wireless hotspot router 140 may maintain a list of access control rules for users of mobile devices in different social groups. For example, these rules may include: allowing all friends of pre-determined social networks to completely use the wireless hotspot router 140; or may define rules for partial access or restricted bandwidth/applications for users in certain groups. An example of partial access may be only allowing email traffic for users that only exchange emails with the host wireless hotspot router 140 such that they can only access predetermined email servers. Rules may also be temporal/location aware such as having the wireless hotspot router 140 only grant access to users attending a weekly meeting at a certain location/time. Thus, many different types of control rules based on upon social relationships may be implemented. Examples of this will be hereinafter described.

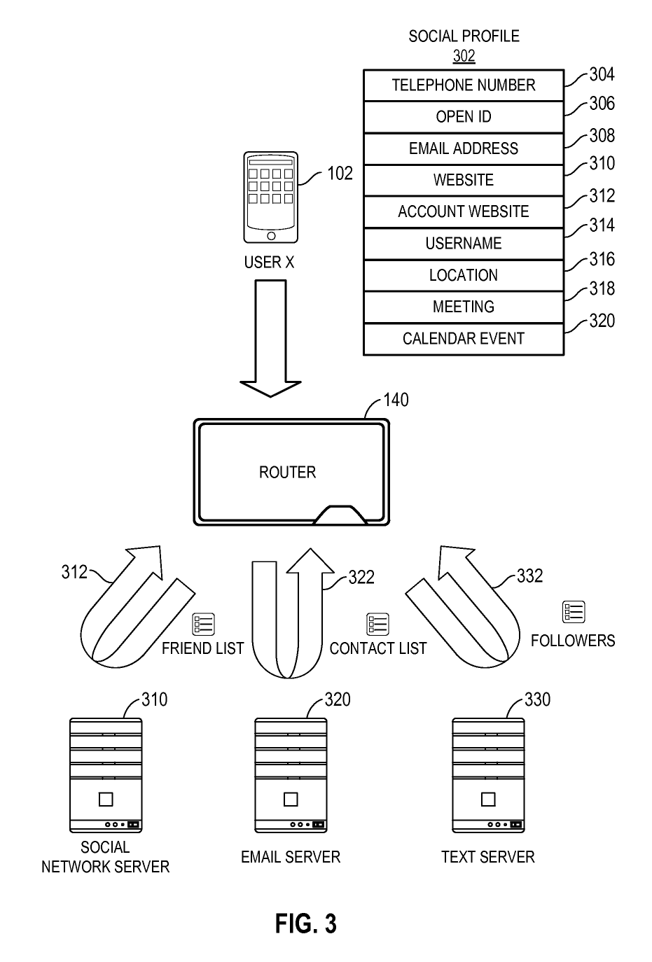

With reference to FIG. 3, an example of authenticating a user of a mobile device 102 to access a social network will be described. If a user of wireless device 102 comes into range of wireless hotspot router 140, the mobile device 102 may transmit a social profile 302 via a wireless link 122 to the wireless hotspot router 140 to bind the mobile device 102 to the router. The social profile 302 may include one or more of the following items: a telephone number 304, an OpenID 306, an email address 308, a website 310 (e.g., a social network website), an account on a website 312, a username 314, a location 316, a meeting 318, a calendar event 320. It should be appreciated that typically only a few items of the social profile 302 may be automatically transmitted from the mobile device 102 to the wireless hotspot router 140 to bind the mobile device, such as a telephone number or a website last visited, and that many of these items will be used as social network credentials requested by the wireless hotspot router 140.

Upon receipt by the wireless hotspot router 140 of a few of these social profile items 302, the wireless hotspot router 140 may command that the mobile device 102 transmit other social network credentials of the social profile 302 to authenticate the mobile device 102 to the wireless hotspot router 140. For example, the wireless hotspot router 140 may request social network credentials related to: the user's username 314, email address 308, OpenID 306, calendar events 320, etc. Based upon authentication by the wireless hotspot router 140, the mobile device 102 may be permitted to access a social network or another mobile device in accordance with control rules set by the router. Additionally, it should be appreciated that after the mobile device 102 has been authenticated based on social network credentials by the router 140, the mobile device 102 may be permitted to not only access a social network but may be permitted to access any type of network (e.g., any type of Internet site). Further, as previously described, mobile device 102 (User X) may be the owner of the router 140 and by binding itself to router 104 based upon a social profile and authenticating itself to router 104 based upon social network credentials, mobile device 102 claims ownership of router 104 (i.e., it is the host) and can set-up and modify the control rules. On the other hand, other mobile devices (e.g., User Y 104 and Z 106) may authenticate themselves to the router 140 based upon social network credentials in a similar manner to that previously described with reference to mobile device 102 (User X) and may be permitted to access a social network 160 or another mobile device based upon the control rules. A social network may include a social network server 310, an email server 320, a text server 332, etc. For example, data from the social network server 310 may be based upon a friends list through link 312, data from the email server 320 may be based upon a contact list through link 322, and data from the text server 330 may be based upon a followers list through link 332.

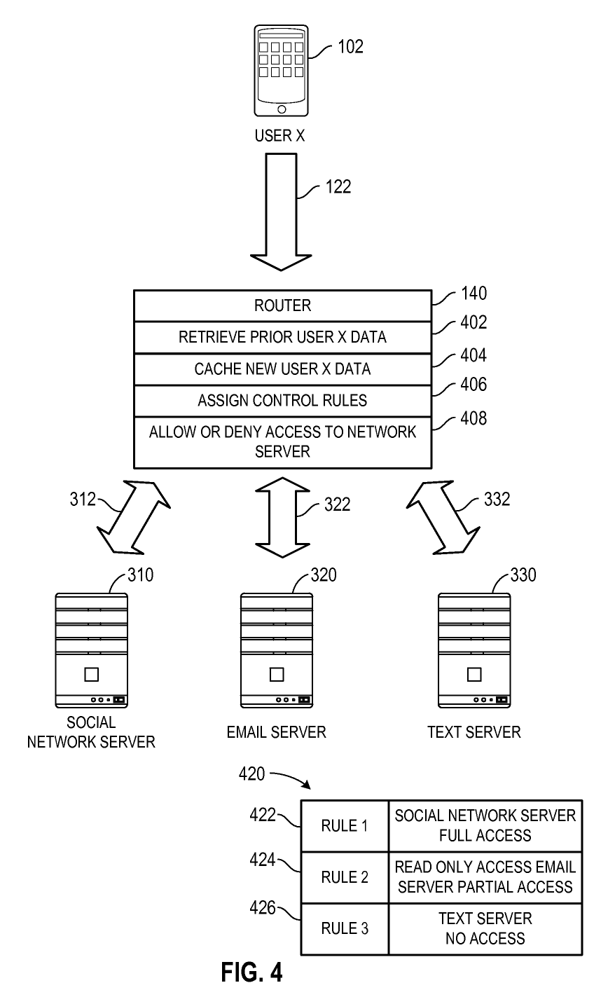

With additional reference to FIG. 4, an example of providing control rules to a user of a mobile device 102 (e.g. User X) to access social networks will be described. Wireless hotspot router 140 may retrieve social network data from memory associated with the transmitted social network credentials from the mobile device 102 of User X. In particular, the wireless hotspot router 140 may retrieve prior User X data 402 as well caching in memory new User X data 404 (e.g., new social network data credentials). Further, wireless hotspot router 140 may assign control rules 406 to the mobile device 102 based upon the retrieved prior User X data 402 and the newer transmitted social network credentials. More, particularly, wireless hotspot router 140 may allow or deny access 408 of the mobile device 102 to one or more of a plurality of different social networks 310, 320, and 330 based upon the assigned control rules 406.

As an example, the wireless hotspot router 140 may retrieve the mobile device's 102 social relationship/interactions with the owner of the wireless hotspot router 140 or of other users of the wireless hotspot router 140, such as, for example: friend's list on a social network website 310, followers/followees on a text website 330, friends that have exchanged emails on an email website 330. However, in this example, wireless hotspot router 140 may determine that User X mobile device 102 is the owner or host.

Access by the wireless hotspot router 140 to the social network server 310, email server 320, and text website 330 may be granted to the mobile device 102 based upon control rules 406. The wireless hotspot router 140 may maintain a list of access control rules for users of mobile devices in different social groups. For example, these rules may include: allowing all friends of pre-determined social networks to completely use the wireless hotspot router 140; or may define rules for partial access or restricted bandwidth/applications for users in certain groups. An example of partial access may be only allowing email traffic for users that only exchange emails with the host wireless hotspot router 140 such that they can only access predetermined email servers. Many different types of control rules based on upon social relationships may be implemented. However, in this example, wireless hotspot router 140 may determine that User X mobile device 102 is the owner or host and may grant full access in accordance with the control rules.

In particular, wireless hotspot router 140 may assign control rules 406 based upon the retrieved social network data and may allow or deny access of the mobile device 102 to one or more of a plurality of different social networks 310, 320, and 330 based upon the assigned control rules 406. In this example, control rules 420 include: Rule 1 420—that User X of mobile device 102 has full access to social network server 310; Rule 2 424—that User X of mobile device 102 has partial access—to only one email server 320; Rule 3 426—that User X has No Access to text server 330. These rules may be based upon: allowing all friends of pre-determined social networks to completely use the wireless hotspot router 140; providing partial access to email in which a user is granted email access only to an email server in which the owner of the wireless hotspot router 140 is a contact; and providing no access to a text server in which there are no related followers or followees.

It should be appreciated that many different types of control rules based upon social relationships may be implemented dependent upon the considerations of the owner of the wireless hotspot router 140 and may programmed by the owner of the wireless hotspot router 140. Therefore, the owner of the wireless hotspot router 140 can particularly control: whether service should be granted and what level of service should be granted dependent upon associations with the mobile client device 102. In this particular example, mobile device 102 (User X) may be the owner of the router 140 (or host) and by binding itself to router 104 based upon a social profile and authenticating itself to router 104 based upon social network credentials, mobile device 102 claims ownership of router 104 and can set-up and modify the control rules 420. On the other hand, other mobile devices (e.g., User Y 104 and Z 106) may authenticate themselves to the router 140 based upon social network credentials and may be permitted to access a social network 160 or another mobile device based upon the control rules—but because User Y 104 and Z 106 are not bound to the router 140 and are not owners of the router 140 they cannot change the control rules 420.

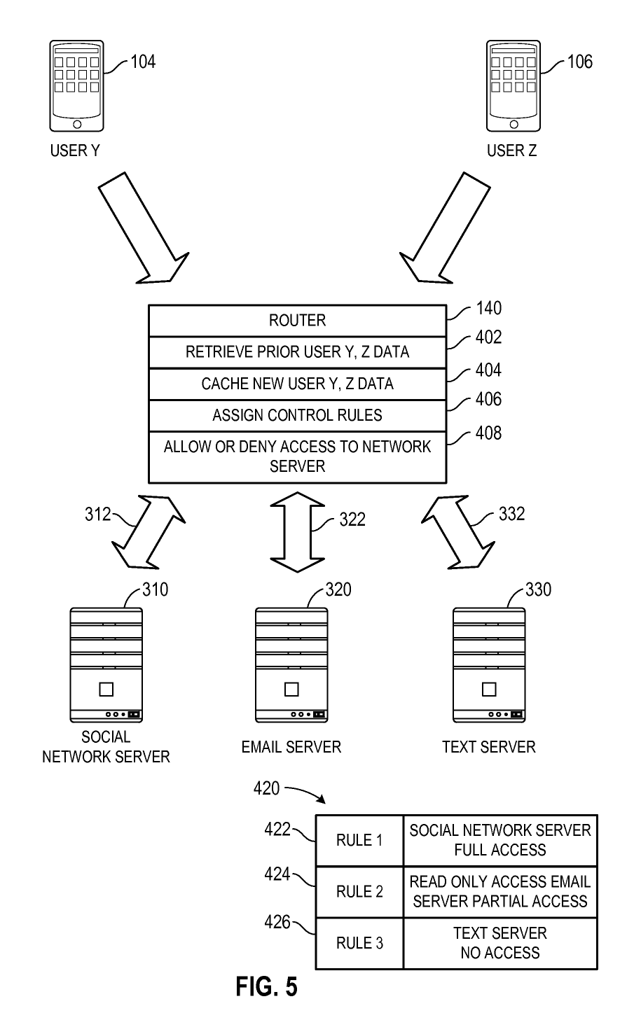

With additional reference to FIG. 5, an example of providing control rules to users of mobile devices 104 and 106 (Users Y and Z) to access social networks will be described. Wireless hotspot router 140 may retrieve social network data from memory associated with the transmitted social network credentials from the mobile devices 104 and 106 (Users Y and Z). In particular, the wireless hotspot router 140 may retrieve prior User Y, Z data 402 as well caching in memory new User Y, Z data 404 (e.g., new social network data credentials). Further, wireless hotspot router 140 may assign control rules 406 to mobile devices 104 and 106 (Users Y and Z) based upon the retrieved prior User Y, Z data 402 and the newer transmitted social network credentials. More, particularly, wireless hotspot router 140 may allow or deny access 408 to mobile devices 104 or 106 (Users Y and Z) to one or more of a plurality of different social networks 310, 320, and 330 based upon the assigned control rules 406. However, it should be appreciated that after the other mobile devices 104 and 106 have been authenticated based on social network credentials by the router 140, the mobile devices 104 and 106 may be permitted by the router to not only access a particular social network but may be permitted to access any type of network (e.g., any type of Internet site)

As an example, the wireless hotspot router 140 may retrieve mobile device's 104 (User Y) social relationship/interactions with the owner of the wireless hotspot router 140 or of other users of the wireless hotspot router 140, such as, for example: friend's list on a social network website 310, followers/followees on a text website 330, friends that have exchanged emails on an email website 330. As one particular example, a Username of User Y could be used to link the user to the wireless hotspot router 140 and this may be used to inform wireless hotspot router 140 that this User Y of mobile device 104 is associated with a particular social network server 310, email server 320, or text website 330. In particular, after successfully authenticating the mobile device user's identity, the wireless hotspot router 140 may begin to match the user with its social relationship/interaction with the host/owner of the wireless hotspot router 140 or other users of the wireless hotspot router 140. Examples of this may include determining—if the user is on one of the host's social networks friends list of social network server 310, if the user has exchanged email with the host on email server 322, or if the host is a follower/followee on a text website 330, etc.

Access by the wireless hotspot router 140 to the social network server 310, email server 320, and text website 330 may be granted to mobile devices 104 or 106 (Users Y and Z) based upon control rules 406. The wireless hotspot router 140 may maintain a list of access control rules for users of mobile devices in different social groups. For example, these rules may include: allowing all friends of pre-determined social networks to completely use the wireless hotspot router 140; or may define rules for partial access or restricted bandwidth/applications for users in certain groups. An example of partial access may be only allowing email traffic for users that only exchange emails with the host wireless hotspot router 140 such that they can only access predetermined email servers. Many different types of control rules based on upon social relationships may be implemented.

In particular, wireless hotspot router 140 may assign control rules 406 based upon the retrieved social network data and may allow or deny access of mobile devices 104 or 106 (Users Y and Z) to one or more of a plurality of different social networks 310, 320, and 330 based upon the assigned control rules 406. In this example, control rules 420 include: Rule 1 420—that Users Y and Z of mobile devices 104 and 106 have full access to social network server 310; Rule 2 424—that Users Y and Z of mobile devices 104 and 106 have partial access—to only one email server 320; Rule 3 426—that Users Y and Z of mobile devices 104 and 106 have—No Access to text server 330. These rules may be based upon: allowing all friends of pre-determined social networks to completely use the wireless hotspot router 140; providing partial access to email in which a user is granted email access only to an email server in which the owner of the wireless hotspot router 140 is a contact; and providing no access to a text server in which there are no related followers or followees. It should be appreciated that many different types of control rules based upon social relationships may be implemented dependent upon the considerations of the owner of the wireless hotspot router 140 and may programmed by the owner of the wireless hotspot router 140. Therefore, the owner of the wireless hotspot router 140 can particularly control: whether service should be granted and what level of service should be granted dependent upon associations with the mobile client device 102.

In particular, as previously described, a mobile client device user's social network interactions may be leveraged to authenticate and control access to the wireless hotspot router 140. In particular, matching the social authentication and context of a mobile client device user with the tethering wireless hotspot router 104 may be used to determine if access should be given and if so to what level of service. For example, if the client mobile device's phone number is in the wireless hotspot router's 140 contact list then it may imply that a simple low level of access should be given. On the other hand, if the mobile client device user is friend on a social network 310 associated with the owner of the wireless hotspot router 140, then a higher level of access may be provided, such as Internet Access to the social network 140. These types of associations may be verified without a large amount of manual interruptions to the user of the mobile client device.

It should be appreciated that embodiments of the invention as previously described may be implemented in conjunction with the execution of instructions by processor 112 of mobile device 102 and/or processor 142 of wireless hotspot router 140 and/or other circuitry of mobile device 102 and wireless hotspot router 140 and/or other devices. Particularly, circuitry of mobile device 102 and wireless hotspot router 140 including but not limited to processors 112 and 142, may operate under the control of a program, routine, or the execution of instructions to execute methods or processes in accordance with embodiments of the invention. For example, such a program may be implemented in firmware or software (e.g. stored in memory and/or other locations) and may be implemented by processors, such as processors 112 and 142, and/or other circuitry. Further, it should be appreciated that the terms processor, microprocessor, circuitry, controller, etc., refer to any type of logic or circuitry capable of executing logic, commands, instructions, software, firmware, functionality, etc. Further, mobile device 102 and wireless hotspot router 140, when utilized as a mobile or wireless device, may communicate via one or more wireless communication links that are based on or otherwise support any wireless communication technology.

The teachings herein may be incorporated into (e.g., implemented within or performed by) a variety of apparatuses (e.g., devices). For example, one or more aspects taught herein may be incorporated into a phone (e.g., a cellular phone), a personal data assistant (“PDA”), an entertainment device (e.g., a music or video device), a headset (e.g., headphones, an earpiece, etc.), a microphone, a medical device (e.g., a biometric sensor, a heart rate monitor, a pedometer, an EKG device, etc.), a user I/O device (e.g., a watch, a remote control, a light switch, a keyboard, a mouse, etc.), a computer, a point-of-sale device, an entertainment device, a set-top box, or any other suitable device.

In some aspects a wireless device may comprise an access device (e.g., a Wi-Fi access point) for a communication system. Such an access device may provide, for example, connectivity to another network (e.g., a wide area network such as the Internet or a cellular network) via a wired or wireless communication link. Accordingly, the access device may enable another device (e.g., a Wi-Fi station) to access the other network or some other functionality. In addition, it should be appreciated that one or both of the devices may be portable or, in some cases, relatively non-portable.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A mobile device comprising:
a user interface; and
a processor to:
command transmitting a social profile associated with the mobile device to a router to bind the mobile device to the router;
command transmitting social network credentials requested by the router to authenticate the mobile device to the router; and
based upon authentication by the router, permitting access to a social network in accordance with control rules set by the router.

2. The mobile device of claim 1, wherein if the mobile device is already logged onto a social network, login credentials are passed on directly from the mobile device to the social network.

3. The mobile device of claim 2, wherein if the mobile device is not already logged onto a social network, the router redirects the mobile device to the social network such that the user is allowed to enter login credentials.

4. The mobile device of claim 1, wherein the router includes at least one of a wireless router, a wired router, or another mobile device.

5. The mobile device of claim 1, wherein the router is an approximately short-range wireless hotspot router.

6. The mobile device of claim 1, wherein the social profile includes at least one of a telephone number, an Open ID, an email address, an account on a website, or a username.

7. The mobile device of claim 6, wherein the social profile includes a physical social interaction including at least one of a location, a meeting, or a calendar event.

8. The mobile device of claim 6, wherein the social network includes a website having a plurality of user accounts.

9. The mobile device of claim 1, wherein another mobile device is permitted access to the social network in accordance with the control rules set by the router.

10. The mobile device of claim 1, wherein after the mobile device has been authenticated based on social network credentials, the mobile device is permitted to access any type of network.

11. A method to allow a user of a mobile device to access a social network comprising:
transmitting a social profile associated with the mobile device to a router to bind the mobile device to the router;
transmitting social network credentials requested by the router to authenticate the mobile device to the router; and
based upon authentication by the router, permitting access to the social network in accordance with control rules set by the router.

12. The method of claim 11, wherein if the mobile device is already logged onto a social network, further comprising passing on login credentials directly from the mobile device to the social network.

13. The method of claim 11, wherein if the mobile device is not already logged onto a social network, further comprising redirecting the mobile device to the social network such that the user is allowed to enter login credentials.

14. The method of claim 11, wherein the router includes at least one of a wireless router, a wired router, or another mobile device.

15. The method of claim 11, wherein the router is an approximately short-range wireless hotspot router.

16. The method of claim 11, wherein the social profile includes at least one of a telephone number, an Open ID, an email address, an account on a website, or a username.

17. The method of claim 16, wherein the social profile includes a physical social interaction including at least one of a location, a meeting, or a calendar event.

18. The method of claim 16, wherein the social network includes a website having a plurality of user accounts.

19. The method of claim 11, further comprising permitting another mobile device to access the social network in accordance with the control rules set by the router.

20. The method of claim 11, wherein after the mobile device has been authenticated based on social network credentials, the mobile device is permitted to access any type of network.

21. A mobile device comprising:
means for transmitting a social profile associated with the mobile device to a router to bind the mobile device to the router;
means for transmitting social network credentials requested by the router to authenticate the mobile device to the router; and
means for permitting access to the social network in accordance with control rules set by the router based upon authentication by the router.

22. The mobile device of claim 21, wherein if the mobile device is already logged onto a social network, further comprising means for passing on login credentials directly from the mobile device to the social network.

23. The mobile device of claim 22, wherein if the mobile device is not already logged onto a social network, further comprising means for redirecting the mobile device to the social network such that the user is allowed to enter login credentials.

24. The mobile device of claim 21, wherein the router includes at least one of a wireless router, a wired router, or another mobile device.

25. The mobile device of claim 21, wherein the router is an approximately short-range wireless hotspot router.

26. The mobile device of claim 21, wherein the social profile includes at least one of a telephone number, an Open ID, an email address, an account on a website, or a username.

27. The mobile device of claim 26, wherein the social profile includes a physical social interaction including at least one of a location, a meeting, or a calendar event.

28. The mobile device of claim 26, wherein the social network includes a website having a plurality of user accounts.

29. The mobile device of claim 21, wherein another mobile device is permitted access to the social network in accordance with the control rules set by the router.

30. The mobile device of claim 21, wherein after the mobile device has been authenticated based on social network credentials, the mobile device is permitted to access any type of network.

31. A computer program product to allow a user of a mobile device to access a social network comprising:
a computer-readable medium comprising code for:
transmitting a social profile associated with the mobile device to a router to bind the mobile device to the router;
transmitting social network credentials requested by the router to authenticate the mobile device to the router; and
based upon authentication by the router, permitting access to the social network in accordance with control rules set by the router.

32. The computer program product of claim 31, wherein if the mobile device is already logged onto a social network, further comprising code for passing on login credentials directly from the mobile device to the social network.

33. The computer program product of claim 32, wherein if the mobile device is not already logged onto a social network, further comprising code for redirecting the mobile device to the social network such that the user is allowed to enter login credentials.

34. The computer program product of claim 31, wherein the router includes at least one of a wireless router, a wired router, or another mobile device.

35. The computer program product of claim 31, wherein the router is an approximately short-range wireless hotspot router.

36. The computer program product of claim 31, wherein the social profile includes at least one of a telephone number, an Open ID, an email address, an account on a website, or a username.

37. The computer program product of claim 36, wherein the social profile includes a physical social interaction including at least one of a location, a meeting, or a calendar event.

38. The computer program product of claim 36, wherein the social network includes a website having a plurality of user accounts.

39. The computer product of claim 31, wherein another mobile device is permitted access to the social network in accordance with the control rules set by the router.

40. The computer product of claim 31, wherein after the mobile device has been authenticated based on social network credentials, further comprising code for permitting the mobile device to access any type of network.

41. A router comprising:
an interface to receive a social profile from a mobile device; and
a processor to:
request the mobile device to transmit social network credentials to the router;
authenticate the mobile device based upon the social network credentials; and
permit access to a social network for the mobile device in accordance with control rules.

42. The router of claim 41, wherein if the mobile device is already logged onto a social network, login credentials are passed on directly from the mobile device to the social network.

43. The router of claim 42, wherein if the mobile device is not already logged onto a social network, the router redirects the mobile device to the social network such that the user is allowed to enter login credentials.

44. The router of claim 41, wherein the router includes at least one of a wireless router, a wired router, or another mobile device.

45. The router of claim 41, wherein the router is an approximately short-range wireless hotspot router.

46. The router of claim 41, wherein the social profile includes at least one of a telephone number, an Open ID, an email address, an account on a website, or a username.

47. The router of claim 41, wherein the social profile includes a physical social interaction including at least one of a location, a meeting, or a calendar event.

48. The router of claim 41, wherein the social network includes a website having a plurality of user accounts.

49. The router of claim 41, wherein the router retrieves social network data associated with the transmitted social network credentials.

50. The router of claim 48, wherein the router assigns control rules to the mobile device based upon the retrieved social network data.

51. The router of claim 50, wherein the router caches the social network credentials and the social network data.

52. The router of claim 51, wherein the router allows or denies access of the mobile device to at least one of a plurality of different social networks.

53. The router of claim 41, wherein another mobile device is permitted access to the social network in accordance with the control rules set by the router.

54. The router claim 41, wherein after the mobile device has been authenticated based on social network credentials, the mobile device is permitted to access any type of network.

55. A computer program product implemented at a router to allow a user of a mobile device to access a social network comprising:
a computer-readable medium comprising code for:
receiving a social profile from the mobile device;
requesting the mobile device to transmit social network credentials to the router;
authenticating the mobile device based upon the social network credentials; and
permitting access to the social network for the mobile device in accordance with control rules.

56. The computer program product of claim 55, wherein if the mobile device is already logged onto a social network, further comprising code for passing on the login credentials directly from the mobile device to the social network.

57. The computer program product of claim 56, wherein if the mobile device is not already logged onto a social network, further comprising code for redirecting the mobile device to the social network such that the user is allowed to enter login credentials.

58. The computer program product of claim 55, wherein the router includes at least one of a wireless router, a wired router, or another mobile device.

59. The computer program product of claim 55, wherein the router is an approximately short-range wireless hotspot router.

60. The computer program product of claim 55, wherein the social profile includes at least one of a telephone number, an Open ID, an email address, an account on a website, or a username.

61. The computer program product of claim 55, further comprising code for retrieving social network data associated with the transmitted social network credentials.

62. The computer program product of claim 61, further comprising code for assigning control rules to the mobile device based upon the retrieved social network data.

63. The computer program product of claim 62, further comprising code for allowing or denying access of the mobile device to at least one of a plurality of different social networks.

64. The computer product of claim 55, further comprising code for permitting another mobile device to access to the social network in accordance with the control rules set by the router.

65. The computer product of claim 55, wherein after the mobile device has been authenticated based on social network credentials, further comprising code for permitting the mobile device to access any type of network.
